(19) United States
(12) Patent Application Publication
(10) Pub. No.: US 2020/0238335 A1
(43) Pub. Date: Jul. 30, 2020

(54) FEEDER ASSEMBLY

(71) Applicant: ISMECA SEMICONDUCTOR HOLDING SA, La Chaux-de-Fonds (CH)

(72) Inventors: Philippe VIVERGE, Le Russey (FR); Valerio OSLER, Boudry (CH); Sylvain VIENOT, Villers-Le-Lac (FR)

(73) Assignee: ISMECA SEMICONDUCTOR HOLDING SA, La Chaux-de-Fonds (CH)

(21) Appl. No.: 16/482,687

(22) PCT Filed: May 2, 2018
(86) PCT No.: PCT/IB2018/053029

§ 371 Date: Jul. 31, 2019

(30) Foreign Application Priority Data
May 11, 2017 (CH) 00636/17

(51) Int. Cl. B07B 1/36; B65G 47/256; B65G 47/24; B65G 47/14; B07B 15/00

(52) U.S. Cl. CPC B07B 1/36; B65G 47/256; B65G 47/24; B07B 2201/04; B07B 15/00; B65G 2203/041; B65G 47/1492

(57) ABSTRACT

A feeder assembly includes a hopper which can receive components to be fed and a sorting means which comprises at least a first mesh and a second mesh having different sized openings. The size of the openings in one of the meshes is larger than the size of the openings in the other mesh, so that the mesh with the larger sized openings can separate good components from malformed components and particles which are larger than the size of a good component, and the mesh with the smaller sized openings can separate good components from malformed components and particles which are smaller than the size of a good component. A first track can receive good components from the sorting means. The first track vibrates so as to move good components along the first track. One or more baffles positioned along the first track move good components into a predefined orientation. Also disclosed area method of feeding and a component handling assembly.

### FIELD OF THE INVENTION

The present invention concerns a feeder assembly, which comprises a stack of meshes, which are used to filter out malformed broken components, or debris, before passing components along a track where they are arranged into a predefined orientation using baffles. There is further provided a corresponding method of feeding components, and a component handling assembly which comprises said feeder assembly.

### DESCRIPTION OF RELATED ART

The most common solutions for feeding components is a vibratory bowl feeder. In component handling assemblies which use such vibratory bowl feeders, baffles are provides along the track (along which the components are moved) inside the blow of the bowl feeder. As a components move along the track in the bowl feeder the baffles will serve to move the components into a predefined orientation. However in some cases the bowls of the bowl feeders are small and many baffles may be required for a particular application; in such a case it can be difficult to incorporate all of the baffles required for a particular application into the small sized bowl of the bowl feeder. Moreover even if all of the baffles are successfully incorporated into the small sized bowl of the bowl feeder the bowl feeder becomes cluttered with baffles.

An even more prevalent problem which arises with existing bowl feeders is that when there is a lot of malformed or broken components are present in a batch of components which are to be fed using the bowl feeder, these malformed or broken components can lead to many interruptions of the feeding process. Specifically malformed or broken components can easily become jammed in the bowl feeder (e.g. jammed at a position along the track of the bowl feeder, or jammed at a baffle); these jammed components block other components from moving along the track of the bowl feeder thus causing an interruption of the feeding process and requiring intervention to free the jammed component to allow the feeding process to continue. In some cases the bowl feeder must be shut-down completely to allow the jammed component to be removed; this of course leads to a longer interruption period.

In particular, batches of ceramic components typically will have a high number of malformed, stacked or broken components. For example a batch of ceramic components may include many components which are clustered (i.e. two or more components fixed together), broken components (e.g. components which are broken into two or more pieces), components which have too much of ceramic dust or which have not hardened properly during the manufacturing process, and/or components which have a deformed shape. All of such components can easily become jammed along the track of the bowl feeder or become jammed at a baffle, thus leading to interruption of the feeding process. Of course the higher the number of malformed components or broke component in a batch which is being fed by the bowl feeder, the higher the number of occurrences of jamming and thus the higher the number of interruptions.

It is an aim of the present invention to mitigate or obviate at least some of the above-mentioned disadvantages associated with existing vibrating bowl feeders.

### BRIEF SUMMARY OF THE INVENTION

According to the invention, the aim of the present invention is achieved by means of the feeder assembly comprising; a hopper which can receive components to be fed, said hopper having a mouth through which said components can be expelled from the hopper;

a sorting means which comprises at least a first mesh and a second mesh having different sized openings, wherein the size of the openings in one of the first or second meshes is larger than the size of the openings in the other mesh, so that the mesh with the larger sized openings can separate good components from malformed components and particles which are larger than the size of a good component, and the mesh with the smaller sized openings can separate good components from malformed components and particles which are smaller than the size of a good component;

a first track which can receive good components from the sorting means;
a first vibration means, for vibrating the first track so as to move said good components along the first track; one or more baffles positioned along the first track, which can cooperate with said good components which move along the first track to move said good components into a predefined orientation.

It should be understood that in the present invention the component(s) preferably comprise ceramic components.

It should be understood that in this application a ‘good component’ is a component which meets a predefined quality level (e.g. a component which has an amount of defect which is less than a predefined defect threshold). In one case a good component may be a component which is has no defect. However, in other cases, a manufacturing tolerance may be allowed for, in such cases components which have minor defects, which are with a predefined tolerance, would be considered to be a good component.

A malformed component may be a component having a defect; for example malformed component may be a component is attached to one or more another components, or, in another example a malformed component could be a component having a deformed shaped.

Also the ‘openings’ in the mesh are the spaces in the mesh which are defined by the network of wires/members which define the mesh.

In an embodiment the sorting means comprise, a first sorting track and a second sorting track, wherein the first sorting track comprises a first mesh which is arranged to overlay a first base, and wherein the second sorting track comprises a second mesh which is arranged to overlay a second base.

The sorting means may comprise, a first vibration means which is operably connected to the first sorting track, and is operable to vibrate the first sorting track to cause components on the first sorting track to move along the first sorting track; and a second vibration means which is operably connected to the second sorting track, and is operable to vibrate the second sorting track to cause components on the second sorting track to move along the second sorting track.

The sorting means may further comprise, a first intermediate track which is arranged to receive components from the first base and direct said components to the second sorting track; and a second intermediate track which is arranged to receive components from a surface of the second mesh and direct said components to said first track.

The sorting means may further comprise a first bin which is arranged to receive malformed components and particles which have moved along a surface of the first mesh; and a second bin which is arrange to receive malformed components and particles which have moved along the second base.

In an embodiment the sorting means may comprise a stack of meshes, said stack comprising a first mesh and a second mesh, the first mesh having openings which are larger than openings of the second mesh so that the size of components which can pass through the first mesh are larger than the size of the components which can pass through the second mesh, wherein the first mesh overlays the second mesh so that components which pass through the opening in the first mesh fall onto the second mesh, and wherein said stack is arranged such that components which are expelled through the mouth of the hopper fall onto the first mesh; a first track which can receive components which do not pass through the second mesh; a first vibration means, for vibrating the first track so as to move components along the first track; one or more baffles positioned along the first track, which can cooperate with components which move along the first track to move said components into a predefined orientation.

A feeder assembly may further comprise a vibration means for vibrating the stack.

In an embodiment the feeder assembly comprises a plurality of vibration means. In one embodiment the feeder assembly comprises a vibration means per mesh. For example a first vibration means for vibrating the first mesh and a second vibration means for vibrating the second mesh.

In an embodiment the second mesh is further provided with a channel which tapers in a direction towards first track, so that when the second mesh is vibrated components will move along the surface of the second mesh towards the first track.

In an embodiment the feeder assembly may further comprise a first bin which is arranged to receive components which do not pass through the first mesh; a second bin which is arranged to receive components which pass through the second mesh.

In an embodiment the first mesh is further provided with a channel which tapers in a direction towards the first bin, so that when the first mesh is vibrated components will move along the surface of the first mesh towards the first bin.

Optionally the feeder assembly may further comprise a conduit which is connected between an end of the channel and the first bin, wherein components which were too large to have passed through the first mesh move from the channel via the conduit into the first bin. In the more preferred embodiment the first bin is arranged at the end of the channel so that components which were too large to have passed through the first mesh can move from the channel directly into the first bin.

In an embodiment the second bin is located beneath the second mesh, so that components which are small enough to pass through the openings in the second mesh fall directly into to the second bin after they have passed through the openings it the second mesh.

In any of the embodiments of the present invention, the feeder assembly may further comprise, a camera which is arranged downstream of said one or more baffles which can capture an image of a component which is on first track, and a processing means for processing the image captured by the camera to determine from the image if said component is in a predefined orientation.

In an embodiment the feeder assembly may further comprise, a second track which is arranged to direct components which have been determined by the processing means to not be in said predefined orientation, back to the sorting means; wherein said second track comprises a first end which is arranged to receive components which have been determined by the processing means to not be in said predefined orientation, from the first track, and a second, opposite end which is arranged to deliver components to the sorting means. Preferably, the second, opposite end of the second track is arranged to deliver components onto the second mesh of the sorting means.

In another embodiment the feeder assembly may further comprise, a second track which is arranged to direct components which have been determined by the processing means to not be in said predefined orientation, back to the first track; wherein said second track comprises a first end which is arranged to receive components which have been determined by the processing means to not be in said predefined orientation, from the first track, and a second, opposite end, which is connected to an intermediate track, wherein the intermediate track is connected between the second end of the second track and the first track so that components arriving at the second end of the second track can pass to the first track via the intermediate track.

The feeder assembly may further comprise a second vibration means, for vibrating the second track so as to move components along the second track from the first end to the second, opposite end.

In one embodiment the said vibration of the second track by the second vibration means, moves components along the second track from the first end of the second track to the second end of the second track where said components are delivered onto the second mesh of the sorting means.

In another embodiment said vibration of the second track by the second vibration means, moves components along the second track from the first end of the second track to the second end of the second track where said components are delivered onto the first track. Most preferably said vibration of the second track by the second vibration means, moves components along the second track from the first end of the second track to the second end of the second track where said components are delivered onto the first track via an intermediate track which is connected between the second end of the second track and the first track.

A feeder assembly may further comprise a blower which can be selectively operated to provide a pulse of airflow which can move a component from the first track to the second track.

Preferably the blower is operably connected to the processing means and the processing means is configured to activate the blower to provide a pulse of airflow only when the processing means determines that a component is not in a predefined orientation.

According to a further aspect of the present invention there is provided a method of feeding components using a feeder assembly according to any one of the above-mentioned embodiments, the method comprising, providing a plurality of components in the hopper; expelling the components from the mouth of the hopper to the sorting means; separating good components from malformed components and particles using said at least first and second meshes of the sorting means; passing said good components from the sorting means to the first track; vibrating the first track using the first vibration means so as to move good components along the first track; using the one or more baffles positioned along the first track to move said good components so as to attempt to move each good component into a predefined orientation.

In an embodiment the step of separating good components from malformed components and particles using said at least first and second meshes of the sorting means, comprises, vibrating a first separating track to cause malformed components and particles which are too large to pass through openings in the first mesh, to move along the surface of the first mesh and into the first bin; and to cause good components and malformed components and particles which are small enough to pass through openings in the first mesh, fall onto the first base and to move along the first base; passing the good components and malformed components and particles which were small enough to pass through openings in the first mesh to a second separating track; vibrating the second separating track to cause malformed components and particles which are small enough to pass through openings in the second mesh, to fall onto a second base and to move along the second base and into a second bin, and to cause good components, which are too large to pass through the openings in the second mesh, move along the surface of the second mesh; passing the good components which are too large to pass through the openings in the second mesh to said first track.

In an embodiment the step of separating good components from malformed components and particles using said at least first and second meshes of the sorting means, comprises, vibrating the first mesh so that components which are smaller than the openings in the first mesh pass through the openings in first mesh and fall onto the second mesh, and so that components which are larger than the openings in the first mesh as moved to a first bin; vibrating the second mesh so that components which are smaller than the openings in the second mesh pass through the openings in the second mesh and fall into a second bin, and so that components which are small enough to have passed through the openings in the first mesh but are too large to pass through the openings in the second mesh are moved to the first track.

Any of the method embodiments may further comprise the steps of, capturing an image of a component which is on the first track, using a camera which is located downstream of the one or more baffles, and processing said captured image using a processing means to determine from the image if the component is in said predefined orientation. It should be understood that most preferably the camera is configured so that it has a field of view of a portion of the first tack which is downstream of the one or more baffles, so that it can capture an image of component which arrives at that region of the first track.

The method may further comprise the step of, if the component is in said predefined orientation then picking the component from the feeder assembly using a component handling head on a turret.

The method may further comprise the step of, if the component is in not in said predefined orientation then, moving the component onto a second track.

In an embodiment the method comprise the step of, if the component is in not in said predefined orientation then, moving the component onto a second track, and vibrating the second track to move the component along the second track to return said component to a transfer track which is connected between the second end of the second track and the first track, so that components arriving at the second end of the second track can pass to the first track via the intermediate track.

In another embodiment the method comprise the step of, if the component is in not in said predefined orientation then, moving the component onto a second track, and vibrating the second track to move the component along the second track to return said component to the sorting means. Preferably, the step of vibrating the second track to move the component along the second track to return said component to the sorting means comprises and vibrating the second track to move the component along the second track to return said component onto the second mesh of the sorting means. The method may further comprise the steps of, moving said component from the sorting means onto the first track.

The method may further comprises the step of moving said component along the first track; and using the one or more baffles positioned along the first track to move said component so as to attempt to move said component into said predefined orientation. Most preferably the one or more baffles positioned along the track are used to move said components into said predefined orientation.

The method may further comprise, repeating the steps of: if the component is in not in said predefined orientation then, moving the component onto a second track; vibrating the second track to move the component along the second track; moving said component onto the first track; moving said component along the first track; and using the one or more baffles positioned along the first track to move said component so as to attempt to move said component into said predefined orientation; until the processor determines that the component is in said predefined orientation.

In an embodiment the method comprises, repeating the steps of: if the component is in not in said predefined orientation then, moving the component onto a second track; vibrating the second track to move the component along the second track to return said component to the sorting means; moving said component from the sorting means onto the first track; moving said component along the first track; and using the one or more baffles positioned along the first track to move said component so as to attempt to move said component into said predefined orientation;

until the processor determines that the component is in said predefined orientation.

In another embodiment the method comprises, repeating the steps of:
if the component is in not in said predefined orientation then, moving the component onto a second track; vibrating the second track to move the component along the second track to a transfer track which is connected; moving said component from the second track onto the first track via the transfer track; moving said component along the first track; and using the one or more baffles positioned along the first track to move said component so as to attempt to move said component into said predefined orientation;
until the processor determines that the component is in said predefined orientation.

In an embodiment the step of moving the component onto a second track comprises, using a blower to provide a pulse of airflow which blows the component from the first track onto the second track.

According to a further aspect of the present invention there is provided a component handling assembly comprising, a feeder assembly according to any one of the above-mentioned feeder assembly embodiments; a rotatable turret, comprising a plurality of component handling heads a rotatable turret, comprising a plurality of component handling heads each of which can hold a respective component by means of a vacuum;
wherein said first track of the feeder assembly has a first end and second opposite end, and wherein the feeder assembly is arranged so that the first end of the first track is arranged to receive components from the sorting means, and the second opposite end of the first track is located under the turret so that component handling heads on the turret can pick components from the second end of the first track.

In an embodiment the first end is arranged to receive components which do not pass through the second mesh of the sorting means.

Preferably the second end of the first track is aligned under a component handling head on the turret.

### BRIEF DESCRIPTION OF THE DRAWINGS

The invention will be better understood with the aid of the description of an embodiment of the present invention, which given by way of example only, and illustrated by the figures, in which:

FIGS. 1a and 1b show perspective views of a feeder assembly according to an embodiment of the present invention;

FIG. 2 shows a magnified perspective view of the sorting means used in the feeder assembly embodiment of FIGS. 1a and 1b;

FIG. 3 shows a magnified perspective view of the first track and the baffles;

FIG. 4 shows a perspective view of a feeder assembly according to a further embodiment of the present invention;

FIG. 5 shows a magnified perspective view of a portion of sorting means which is used in the feeder assembly embodiment of FIG. 4.

### DETAILED DESCRIPTION OF POSSIBLE EMBODIMENTS OF THE INVENTION

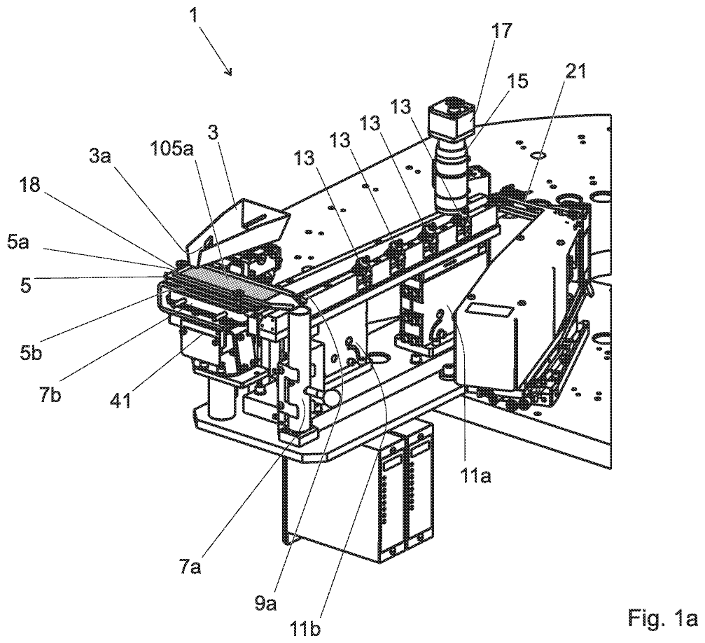

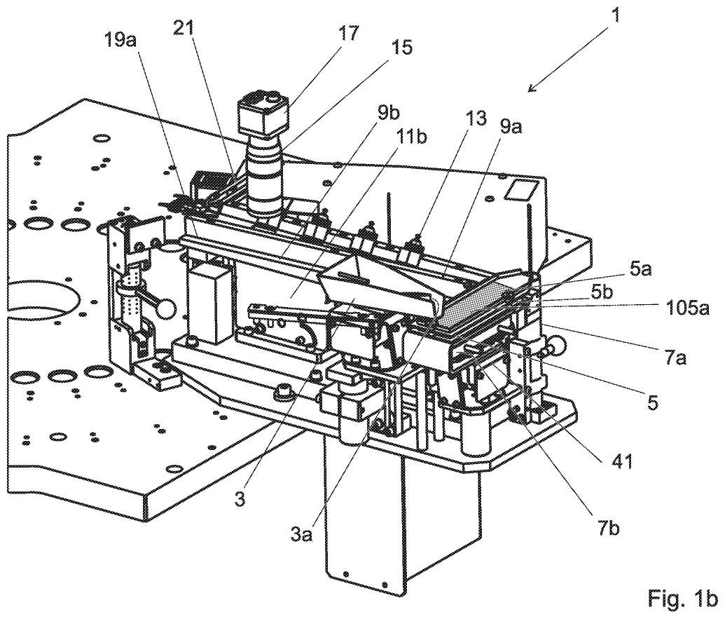

FIGS. 1a and 1b show a perspective view of a feeder assembly 1 according to an embodiment of the present invention.

The feeder assembly 1 comprises a hopper 3 which can receive components which are to be fed. The hopper 3 comprises a mouth 3a through which components can be expelled from the hopper 3.

The feeder assembly 1 further comprises a sorting means 18. The sorting means 18 comprises a stack 5 of meshes, said stack 5 comprising a first mesh 5a and a second mesh 5b. The first mesh 5a has openings 105a which are larger than openings of the second mesh 5b so that the size of components, which can pass through the first mesh 5a are larger than the size of the components which can pass through the second mesh 5b. It should be noted that the openings in the second mesh 5b are not visible in FIGS. 1a and 1b because the view of the openings in the second mesh are obstructed by the overlaying first mesh 5a.

It should be understood that the stack 5 may comprise any number of meshes. Preferable the stack 5 comprises two or more meshes; and the meshes are arranged in the stack in the order of the decreasing size of their openings, with the mesh with the largest openings being provided at the top of the stack 5 while the mesh with the smallest openings is provided at the bottom of the stack 5.

A first bin 7a which is arranged to receive components which do not pass through the first mesh 5a; and a second bin 7b is arranged to receive components which have passed through both the first and second meshes.

Referring to FIG. 1a it is shown that the feeder assembly further comprises a first track 9a which is arranged to receive components which have passed through the first mesh but which do not pass through the second mesh. A first vibration means 11a is further provided for vibrating the first track 9a so as to move components along the first track 9a (preferably so as to move components along the first track 9a towards a turret picking system). In other words the vibration of the first track 9a cause components which are on the track 9a to shuffle or hop along the first track 9a so that the component moves linearly from one end of the first track 9a to the opposite end of the first track 9a.

Positioned along the first track 9a there is provided one or more baffles 13 which can mechanically cooperate with respective components which move along the first track 9a so as to orientate said components into a predefined orientation. Collectively if each baffle 13 along the first track 9a has successfully orientated a passing component in the manner in which it is intended then that component will have been moved into a predefined orientation. It should be understood that any number of baffles 13 may be provided; and the baffles may take any suitable configuration.

The feeder assembly 1 further comprises a camera 15 which is arranged downstream of said one or more baffles 13 which can capture an image of a component after the component has moved along the first track 9a; and a processing means in the form of a processor 17, for processing the image captured by the camera to determine from the image if the component (whose image was captured) is in a predefined orientation. The processing 17 is connected to the camera by a wired (e.g. using one or more cables such as a bus for example) or wireless connection (e.g. blue tooth or near field communication etc.) so that image data (i.e. an image captured by the camera) can be passed from the camera 15 to the processor 17 for processing.

Referring to FIG. 1b it can be seen that the feeder assembly 1 further comprises second track 9b having a first end 19a which is arranged such that it can receive components which have been determined by the processor 17 to not be in said predefined orientation, and a second, opposite end 19b which is arranged to deliver components back onto the second mesh 5b. A second vibration means 11b, is further provided for vibrating the second track 9b so as to move components back along the second track 9b from the first end 19a of the second track 9b to the second end 19b where the components are delivered onto the second mesh 5b.

In this particular example the feeder assembly 1 further comprises a blower 21 which can be selectively operated to provide a pulse of airflow which can move a component from the first track 9a to the second track 9b. The blower 21 is connected to the processor 17 (by wireless or wired connection) and the processor 17 activates the blower to provide a pulse of airflow only when the processor 17 determines that a component is not in said predefined orientation. For example, the camera 15 captures an image of a component which has moved along the first track to a position on the first track 9a which is aligned under the camera 15; the captured image is sent to the processor 7 and the processor 7 determines from the image if the component is in a predefined orientation; if the processor 7 determines if the component is not in the predefined orientation then the processor 7 activates the blower 21 provide a pulse of airflow which moves the component from the first track 9a onto the second track 9b; the component is then moved along the second track 9b and at the second end 19b of the second track 9b it is delivered onto the second mesh 5b.

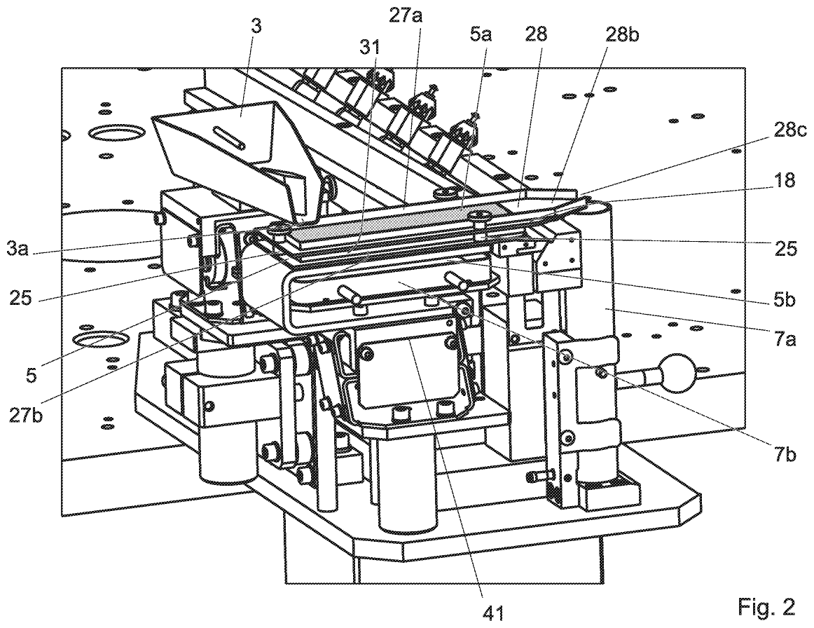

FIG. 2 shows a magnified perspective view of the sorting mean 18 used in the feeder assembly 1. As already described the sorting mean 18 comprises a stack 5 which comprises a first mesh 5a and a second mesh 5b. The first mesh 5a has openings 105a and the second mesh 5b also has openings; it should be noted that the openings in the second mesh 5b are not visible in FIG. 2 because the view of the openings in the second mesh are obstructed by the overlaying first mesh 5a. The openings 105a in the first mesh 5a are larger than openings in the second mesh 5b so that the size of components which can pass through the first mesh 5a are larger than the size of the components which can pass through the second mesh 5b. Specifically the openings 105a in the first mesh 5a are large enough to allow components which is not malformed (i.e. a good component) to pass through the first mesh 5a, and the openings in the second mesh 5b are small enough to ensure that components which is not malformed (i.e. a good component) cannot pass through the openings in the second mesh 5b. The openings in the second mesh 5b are large enough to allow broken components and debris (such as dust) to pass through the openings in the second mesh 5b.

It should be understood that in this application a ‘good component’ is a component which meets a predefined quality level (e.g. a component which has an amount of defect which is less than a predefined defect threshold). In one case a good component may be a component which is has no defect. However, in other cases, a manufacturing tolerance may be allowed for, in such cases components which have minor defects, which are with a predefined tolerance, would be considered to be a good component.

As previously mentioned it should be understood that the stack 5 may have any number of meshes; for example the stack 5 may have more than two meshes.

It will be understood that the openings in the first and second meshes may take any suitable shape (for example, the openings may be circular, square or hexagonal for example). Preferably the shape of the openings is selected depending on the components (i.e. depending on the shape and dimension of the components) which are to be fed.

In one embodiment a plurality of different meshes is provided, the size (and/or shape) of the openings 105a,b differing between each respective mesh, and a user selects from the plurality of different meshes, based on the dimensions of components which is not malformed (i.e. based on the dimensions of a good component) which are to be fed, a first mesh which has openings which are larger than the largest dimensions of the good components, and a second mesh which has openings which are smaller than the smallest dimensions of the good components. The selected first and second mesh are then, used as the first and second mesh 5a,5b in the stack 5 of the feeder assembly. Thus depending on the size/dimensions of the good components which are to be fed the appropriate meshes having the appropriate sized openings are selected and used in the stack 5 of the feeder assembly 1. To find the size/dimensions of a good component a sample good component may be taken from the batch of components which is to be fed and that sample good component measured to determine its size/dimensions.

Reverting to FIG. 2, it can be seen that the first mesh 5a is stacked on the second mesh 5b. In other words, the first mesh 5a and second mesh 5b overlay one another (and preferably are aligned). As a result components which pass through the openings in the first mesh 5a fall directly onto the second mesh 5b. The stack 5 is arranged within the feeder assembly so that components which are expelled through the mouth 3a of the hopper 5 fall directly onto the first mesh 5a.

In this exemplary embodiment the second bin 7b is located beneath the second mesh 5b; in other words the stack 5 is arranged so that it directly overlays the second bin 7b or more specifically the stack 5 is arranged so that the second mesh 5b directly overlays the second bin 7b. As a result, malformed components (i.e. ‘bad component’) which were small enough to pass through both the openings in the first mesh 5a and the openings in the second mesh 5b will fall directly into the second bin 7b after passing through the openings the second mesh 5b.

Spacers 25 are provided between first mesh 5a and the second mesh 5b so as to maintain a gap 31 between the first and second meshes 5a,5b. The spacers 25 are dimensions to as to provide a gap 31 which is large enough to allow ‘good components’ (i.e. components which are not malformed) which are on the surface of the second mesh 5b (i.e. components which were small enough to have passed through the openings in the first mesh 5a, but too large to pass through the openings in the second mesh 5b) to be moved along the surface of the second mesh 5b to the first track 9a. In other words the spacers 25 are dimensioned so that they provide a space between the first and second meshes 5a, 5b which is greater than the largest dimension of a good component. In other words the first and second mesh 5a,5b are spaced apart (by the spacers 25) in the stack 5, by a distance which is greater than the largest dimension of the a good component.

The feeder assembly 1 further comprises a vibration means 41 which is arranged to selectively vibrate the stack 5. The vibrating means 41 compromises a servo motor actuating an eccentric cam in order to generate the lateral motion of the first and second meshes 5a,5b in the stack 5 to cause the first and second meshes 5a,5b to vibrate (i.e. to cause the stack 5 to vibrate). The vibration of the stack 5 by the vibration means 41 will have a number of advantageous effects: for one it will cause the components to filter through the first and second meshes 5a,b quicker. Furthermore, the vibration of the stack 5 can be used to move the components which remain on the surface of a mesh 5a,5b (i.e. those components which are too large to pass through the openings of the first or second mesh 5a,5b) in a desired linear direction over the surface of that mesh 5a,5b. In particular the vibration of the stack 5 moves the components which are too large to pass through the openings in the first mesh 5a (i.e. components which are malformed i.e. ‘bad components’ such as components which are stuck together) to over the surface of the first mesh 5a to a position where they will fall into the first bin 7a. Also, the vibration of the stack 5 moves the components which were small enough to pass though the openings 105a in the first mesh 5a but too large to pass through the openings in the second mesh 5b (i.e. components which are not malformed i.e. ‘good components’) to move over the surface of the second mesh 5b to a position where they are received onto the first track 9a. Further the vibration of the stack 5 will cause debris and components which are small enough to pass through the openings 105a in the first mesh 5a and also through the openings in the second mesh 5b (i.e. components which are malformed or broken components i.e. ‘bad components’) to pass quicker through the openings in the first and second meshes 5a,5b and into the second bin 7b.

The first mesh 5a further comprises a first lip 27a, which is arranged to define a first channel 28a on the surface of the first mesh 5b; the first channel 28a has a portion 28b which tapers in a direction towards a first mouth 28c which leads to the first bin 7a. The components, which were too large to have passed through the openings in the first mesh 5a are moved (by the vibration of the stack) along the first channel 28a towards first mouth 28c; through the first mount 28c and into the first bin 7a. The first lip 27a will serve to retain the components within the first channel 28a so that the components move towards the first mouth 28c, and ultimately into the first bin 7a, when the stack 5 is vibrated by the vibration means 41.

The second mesh 5b further comprises a second lip 27b which is similar to the first lip 27a on the first mesh 5b. The second lip 27b arranged to define a second channel (not visible) on the surface of the second mesh 5b; the second channel has a similar configuration to the first channel 28a on the first mesh 5a in that the second channel has a portion which tapers in a direction towards a second mouth. Importantly, the second mouth of the second channel leads to the first track 9a. The second lip 27b will serve to retain the components (i.e. components which were small enough to pass through the openings in the first mesh 5a but too large to pass through the openings in the second mesh 5b i.e. ‘good components’) within the second channel so that the components move towards the second mouth, and ultimately onto the first track 9a, when the stack 5 is vibrated by the vibration means.

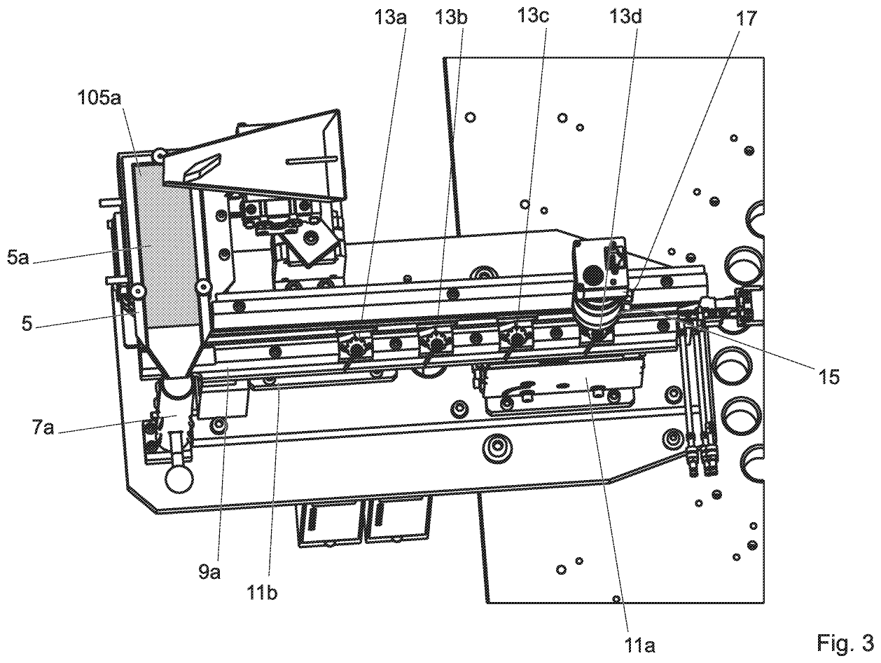

As mentioned it should be understood that any number of baffles 13 may be provided; and the baffles may take any suitable configuration; different configurations for the baffles are well known in the art. FIG. 3 shows a magnified perspective view of the first track 9a and the baffles 13 in the feeder assembly of FIG. 1.

In this particular example four baffles 13a-d are provided along the first track 9a each baffle is configured to move a component in a particular matter; for example a first baffle 13a may configured to move a component from a prone orientation to an upright orientation (i.e. from a horizontal to a vertical orientation); a second baffle 13b for which is configured to rotate the component etc; collectively if each baffle 13a-d has successfully moved a component in the manner in which it is intended then the component will have been moved into a predefined orientation.

The feeder assembly shown in FIG. 1 can be used to perform a method of feeding components according to a further aspect of the present invention. During use of the feeder assembly 1 of FIG. 1 a batch of components which are to be fed are provided into the hopper 3. Typically the batch will comprise some good components (i.e. components which are not malformed) and some bad components (i.e. components which are malformed, have a deformation, or are broken). Usually the batch of components will be a batch of ceramic components.

After the batch of components have been provided in the hopper 3, the components are expelled from the mouth 3a of the hopper 3 onto the first mesh 5a of the stack 5 of meshes.

The stack 5 is vibrated using the vibrating means 41.

Components which are larger than the openings in the first mesh 5a (i.e. bad components—such as compound components i.e. two or more components which are stuck together, or components which have a deformed shape) will remain on the surface of the first mesh 5a. The vibration of the stack by the vibrating means 41 will cause these bad components to move along the first channel 28a towards first mouth 28c; through the first mount 28c and into the first bin 7a. The first lip 27 will serve to retain the bad components within the first channel 28a so that these components move towards the first mouth 28c, and ultimately into the first bin 7a, when the stack 5 is vibrated by the vibration means 41.

Components which are smaller than the openings in the first mesh 5a will pass through the openings in the first mesh 5a and fall onto the second mesh 5b. The vibration of the stack 5 by the vibration means 41 will cause these components to pass quicker through the openings in the first mesh 5a.

Components which are smaller than the openings in the second mesh 5b (i.e. bad components—such as a component which have become broken into two or more parts, or components which have a deformed shape) will pass through the openings in the second mesh 5b and will fall directly into the second bin 7b (which is beneath the second mesh 5b). The vibration of the stack 5 by the vibration means 41 will cause these bad components to pass quicker through the openings in the second mesh 5b.

Components which were small enough to pass through the openings in the first mesh 5a but too large to pass through the openings in the second mesh 5b (i.e. ‘good components’) will remain on the surface of the second mesh 5b. The vibration of the stack 5 by the vibrating means 41 will cause these good components to move along the second channel 29a towards the second mouth 29c; through the second mouth 29c and onto the first track 9a. The second lip 27b will serve to retain the good components within the second channel 29a so that these good components move towards the second mouth 29c, and ultimately are moved onto the first track 9a, when the stack 5 is vibrated by the vibration means 41.

The first vibrating mean 11 is used to vibrate the first track 9a so that the good components, which have been passed onto the first track 9a from the second channel 29a, are moved along the first track 9a. In other words the vibration of the first track 9a causes the good components which are on the track 9a to shuffle or hop along the first track 9a so that the component move linearly from one end of the first track 9a to the opposite end of the first track 9a. Importantly, at the second mouth of the second channel, the good components will be passed consecutively onto the first track 9a; the good components will then be moved in single file along the first track 9a.

Each respective component which is moving along the first track 9a will encounter the baffles 13 which are provided along the first track 9a. Each baffle 13 will mechanically cooperate with the respective good components which move along the first track 9a so as to move said good components into a predefined orientation. If each baffle 13 along the first track 9a is successfully moved a passing good component in the manner in which it is intended, then that good component will have been moved into a predefined orientation.

After the a good component has passed through each of the baffles 13 that good components will arrive a region of the first track 9a which is located beneath the camera 15 (i.e. a region of the first track 9a that the camera overlays). At this position the camera 15 captures an image of the good component.

The image captured by the camera 15 is communicated to the processor 17 which processes the image captured by the camera to determine from the image if the good component (whose image was captured) is in the predefined orientation. Processing the image captured by the camera to determine from the image if the good component (whose image was captured) is in the predefined orientation can be done in any suitable manner; for example the processor 17 may compare the captured image to a reference image which shows a good component in the predefined orientation, and if the position of the good component in the captured image differs from the position of the component in the reference image by an amount which is less than a predefined displacement amount, then it will be determined that the good component is in the predefined orientation, otherwise it determined that the good component is not in the predefined orientation. In another example the fiducials or reference marks are provided on the first track 9a in said region of the first track 9a where the image of the good component is captured, these fiducials or reference marks being in the field of view of the camera 15; the processor 17 then determines from the image the displacement of the good component with respect to these fiducials or reference marks and if the displacement amount is less than a predefined displacement amount, then it will be determined that the good component is in the predefined orientation, otherwise it determined that the good component is not in the predefined orientation. It will be understood that any suitable means known in the art for processing an image of a component to determine if that component is in a predefined position/orientation may be used in the present invention.

If the processor 17 determines that the good component is not in the predefined orientation, then: the processor 17 will first initiate the blower 21 to provide a pulse of airflow which moves the good component from the first track 9a to the second track 9b; more specifically the blower 21 will provide a pulse of airflow which moves the good component from the first track 9a to the first end 19a of the second track 9b. The second track 9b is vibrated using the second vibrating means 11b; the vibration of the second track 9b to move the good component along the second track 9a, from the first end 19a of the second track 9b to the second end 19b of the second track 9b. At the second end 19b of the second track 9b the good component is delivered onto the second mesh 5b. The good component 5b will be passed back onto the first track 9a via the second channel 29a (in the same manner as described above) and will be moved along the first track 9a for a second time where the baffles 13 will attempt, for a second time, to move the good component into said predefined orientation. Again after the good component has been passed along the first track the camera 15 will again take an image of the good component and the processor 17 will process the image to determine if this time the good component is in the predefined orientation. If the processor 17 determines that once again the component is not in the predefined orientation then the above-mentioned steps are repeated.

So in other words when a good component which has been passed along the first track is determined to not be in the predefined orientation then it is sent back to the second mesh 5b where is it delivered once again to the first track 9a; that good component is moved along the first track 9a where once again the baffles will attempt to move that good component into the predefined orientation. These steps are repeated until the good component finally attains the predefined orientation after having passed along the first track 9a.

If the processor 17 determines from the image captured by the camera 15, that a good component (which has passed along the first track 9a) is in the predefined orientation, then that good component then picked from the first track 9a.

Specially, in a further aspect of the present invention there is provided a component handling assembly comprising the feeder assembly 1 and a rotatable turret which comprises a plurality of component handling heads each of which can hold a respective component by means of a vacuum. The feeder assembly is arranged such said first track has a first end and second opposite end, wherein the first end receives good components from the second mouth of the second channel, and the second, opposite end is a portion of the first track 9a which is located downstream of the portion of the first track 9a which is in the field of view of the camera 15. Importantly the feeder assembly 1 is positioned such that the second, opposite end of the first track 9a is located beneath the turret so that component handling heads on the turret can pick good components directly from the second end of the first track; most preferably the feeder assembly 1 is positioned such that the second, opposite end of the first track 9a is aligned under a component handling head on the turret.

If the processor 17 determines from the image captured by the camera 15, that a good component (which has passed along the first track 9a) is in the predefined orientation, then that good component is allowed to continue to move along the first track 9a to the second end of the first track 9a. At the second end of the first track 9a, a component handling head on the turret picks that good component from the first track 9a.

As mentioned the components are moved in single file along the first track 9a. Thus when a good component is picked from the second end of the first channel 9a, the next good component will move to the second end of the first track 9a. The turret rotates iteratively, a component handling head picks a good component from the second end of the first channel 9a the turret is rotate so that the next component handling head arrives at a position where it can pick the next good component which is at the second end of the first track 9a. In this manner consecutive component handling heads on the turret will pick respective consecutive good components which arrive at the second end of the first channel 9a.

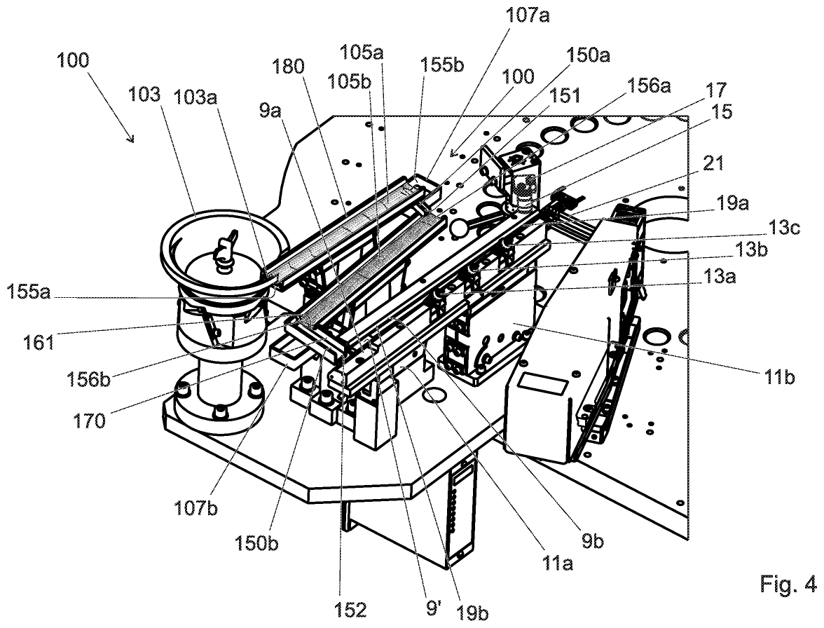

FIG. 4 provides a perspective view of a feeder assembly 100 according to a further embodiment of the present invention. The feeder assembly 100 has many of the same features as the feeder assembly 1 shown in FIGS. 1a and 1b and like features are awarded the same reference numbers.

The feeder assembly 100 comprises a hopper 103 in the form of a bowl hopper 103; components which are to be fed can be provided into said bowl hopper 103. The bowl hopper 103 comprises a mouth 103a through which components (including good components and malformed components) and particles can be expelled from the hopper 3.

The feeder assembly 100 further comprises a sorting means 180. The sorting means 180 comprises a first sorting track 105a and a second sorting track 105b. It will be understood that the feeder assembly 100 of the present invention is not limited to requiring two sorting tracks, the feeder assembly 100 may have more (or less) than two sorting tracks. For example the feeder assembly 100 may have more than two sorting tracks each respective sorting track having meshes with different sized openings so that different sized components can pass through the different meshes on each track.

The first sorting track 105a has a first end 155a and a second, opposite end 155b. The first sorting track 105a is arranged such that the first end 155a of the first sorting track 105a is located at the mouth 103a of the hopper feeder 103 so that components (including good components and malformed components) and particles which are expelled from the bowl hopper 103 are provided on to the first sorting track 105a.

The feeder assembly 100 further comprises a first bin 107a. The first bin 107a is located at the second, opposite, end 155b of the first sorting track 105a. A first intermediate track 150a is also located at the second, opposite, end 155b of the first sorting track 105a. The first intermediate track 150a leads to the second sorting track 105b; specifically the first intermediate track 150 has a mouth 151 which is located above the second sorting track 105b (and is aligned over the second sorting track 105b). The first intermediate track 150a is tilted, so that components (including good components and malformed components) and particles which are delivered from the first sorting track 105a onto the first intermediate track 150a, will move along the first intermediate track 150a under the influence of gravity, and onto the second sorting track 105b.

The second sorting track 105b has a first end 156a and a second, opposite, end 156b. The first end 156a of the second sorting track 105b is located at the mouth 151 of the first intermediate track 150a.

The feeder assembly 100 further comprises a second bin 107b. The second bin 107b is located at the second, opposite, end 156b of the second sorting track 105b. A second intermediate track 150b is also located at the second, opposite, end 156b of the second sorting track 105b. The second intermediate track 150b leads to the first track 9a; specifically the second intermediate track 150b has a mouth 152 which is located above the first track 9a (and is aligned over the first track 9a). The second intermediate track 150b is tilted, so that components (good components) which are delivered from the second sorting track 105b onto the second intermediate track 150b, will move along the second intermediate track 150b under the influence of gravity, and onto the first track 9a.

The feeder assembly 100 further comprises first vibration means 111a and a second vibration means 111b. The first vibration means 111a is operably connected to the first sorting track 105a such that the first vibration means 111a is operable to vibrate the first sorting track 105a. The vibration of the first sorting track 105a will cause components (including good components and malformed components) and particles which are on the first sorting track 105a, to move along the first sorting track 105a. In other words the vibration of the first sorting track 105a causes the components (including good components and malformed components) which are on the first sorting track 105a to shuffle or hop along the first sorting track 105a so that said components and particles move linearly from the first end 155a of the first sorting track 105a to the second, opposite, end 155b of the first sorting track 105a.

The second vibration means 111b is operably connected to the second sorting track 105b, such that the second sorting track 105b is operable to vibrate the second sorting track 105b. The vibration of the second sorting track 105b will cause components (including good components and malformed components) and particles which are on the second sorting track 105b, to move along the second sorting track 105b. In other words the vibration of the second sorting track 105b causes components (including good components and malformed components) and particles which are on the second sorting track 105b to shuffle or hop along the second sorting track 105b so that said components and particles move linearly from the first end 156a of the second sorting track 105b to the second, opposite, end 156b of the second sorting track 105b.

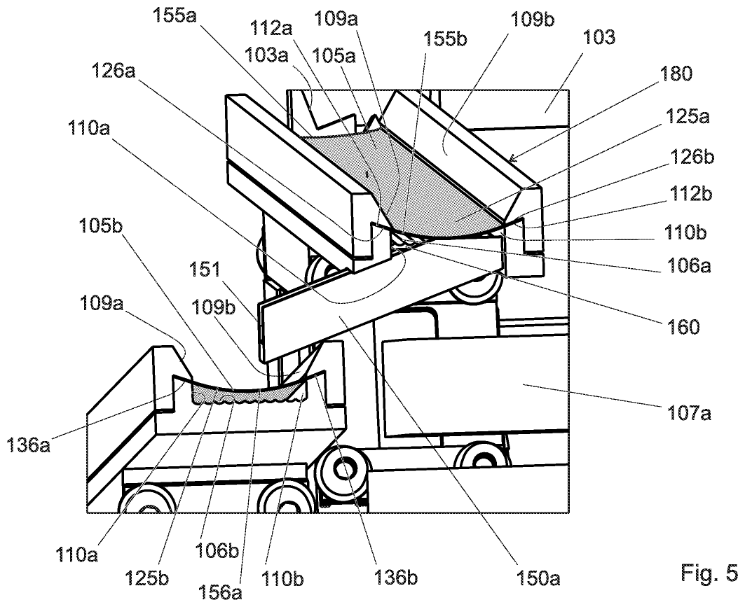

FIG. 5 provides a perspective view of the first and second sorting tracks 105a,105b of the sorting means 180. The first sorting track 105a comprises first mesh 125a and the second sorting track 105b comprises a second mesh 125b. The first mesh 125a has openings (i.e. the openings which are defined by the network of wires/members which define the first mesh 125a. Said openings are not visible in the drawings) which are larger than openings (i.e. the openings which are defined by the network of wires/members which define the second mesh 125b. Said openings are not visible in the drawings) of the second mesh 125b so that the size of objects, which can pass through the first mesh 125a are larger than the size of the objects which can pass through the second mesh 125b. It should be noted that the openings in the first mesh 125a and second mesh 125b are not visible in FIG. 5.

The first sorting track 105a further comprises first base 106a which is located beneath the first mesh 125a. The second sorting track 105b further comprises a second base 106b which is located beneath the second mesh 125b.

In this embodiment both the first sorting track 105a further comprises first side walls 109a,109b, located at opposite sides of the first mesh 125a and which extend along the length of the first mesh 125a, preferably along the whole length of the first mesh 125a. In this example said first side walls 109a,109b have a tapered profile, however it will be understood that the first side walls 109a,109b have any suitable profile. The first sorting track 105a further comprises second side walls 110a,110b, located at opposite sides of the first base 106a and which extend along the length of the first base 106a, preferably along the whole length of the first base 106a. In this example the respective first side walls 109a,109b are stacked on respective second side walls 110a,110b and respective first and second interfaces 112a,112b are defined therebetween. A first side 126a of the first mesh 125a is located at the first interface 112a between the first and second side walls 109a,110a, and a second side 126b of the first mesh 125a is located at the second interface 112b between the first and second side walls 109b,110b.

Likewise the second sorting track 105b further comprises first side walls 109a,109b, located at opposite sides of the second mesh 125b and which extend along the length of the second mesh 125b, preferably along the whole length of the second mesh 125b. In this example said first side walls 109a,109b have a tapered profile, however it will be understood that the first side walls 109a,109b have any suitable profile. The second sorting track 105b further comprises second side walls 110a,110b, located at opposite sides of the second base 106b and which extend along the length of the second base 106b, preferably along the whole length of the second base 106b. In this example the respective first side walls 109a,109b are stacked on respective second side walls 110a,110b and respective first and second interfaces 112a,112b are defined therebetween. A first side 136a of the second mesh 125b is located at the first interface 112a between the first and second side walls 109a,110a, and a second side 136b of the second mesh 125b is located at the second interface 112b between the first and second side walls 109b,110b.

The first mesh 125a extends from the mouth 103a of the bowl hopper 103, over the first intermediate track 150a, to above a first bin 107a. The first base 106a extends from the mouth 103a of the hopper to the first intermediate track 150a.

The first bin 107a is located below the level of the first mesh 125a so that components (malformed components) and particles which have been moved along the surface of the first mesh 125a to the second, opposite, end 155b of the first sorting track 105a (i.e. those malformed components and particles which were too large to fit though the openings in the first mesh 125a), can fall, under the influence of gravity, into the first bin 107a.

The first intermediate track 150a is arranged to receive components (good components and malformed components) and particles which have been moved along the first base 106a to the second, opposite, end 155b of the first sorting track 105a (i.e. the first intermediate track 150a is arranged to receive those good components and malformed components and particles which were small enough to pass though the openings in the first mesh 125a). In this particular embodiment the first intermediate track 150a is arranged at an end extremity 160 of the first base 106a so that the components (good components and malformed components) and particles which have been moved along the first base 106a will fall, under the influence of gravity, from the end extremity 160 of the first base 106a directly onto the first intermediate track 150a. In this example the first mesh 125a is configured to be longer than the first base 106a; in particular the first mesh 125a is configured to extend beyond the first intermediate track 150a thus reducing the risk of components (malformed components) and particles which are on the surface of the first mesh 125a from passing from the surface of the first mesh 125a onto the first intermediate track 150a.

FIG. 4 provides a magnified perspective view of a portion of the sorting means 180 used in the feeder assembly 100. Referring to both FIGS. 4 and 5, the second mesh 125b extends from below the first intermediate track 150a (i.e. from below the mouth 151 of the first intermediate track 150a) to the second intermediate track 150b. The second base 106b extends from below the first intermediate track 150a (i.e. from below the mouth 151 of the first intermediate track 150a) to above the second bin 107b.

As can be best seen from FIG. 4, the second bin 107b is located below the level of the second base 106b so that components (malformed components) and particles which have been moved along the second base 106b to the second, opposite, end 156b of the second sorting track 105a (i.e. those malformed components and particles which were small enough to pass though the openings in the second mesh 125b), can fall, under the influence of gravity, into the second bin 107b.

The second intermediate track 150b is arranged to receive components (i.e. good components) which have been moved along the surface of the second mesh 105b to the second, opposite, end 156b of the second sorting track 105b.

In this particular embodiment the second intermediate track 150b is arranged at an end extremity 161 of the second mesh 125b so that components (i.e. good components) will move from the end extremity 161 of the second mesh 125b directly onto the second intermediate track 150b. In this example the second intermediate track 150b comprises side walls 170 which prevent component from becoming displaced from the second intermediate track 150b e.g. to prevent the components from hopping from the second intermediate track 150b into the second bin 106b. The second bin 107b is located below an end extremity (not visible in the drawings) of the second base 106b so that components (i.e. malformed components) and particles will fall, under the influence of gravity, from the end extremity of the second base 106b directly onto the second intermediate track 150b.

It should be understood that the first and second meshes 125a,b of the feeding assembly 100 can be replaced with other meshes having different sized openings. Thus preferably the feeding assembly 100 will further include a plurality of additional meshes (which can be selectively used to define said first and/or second mesh 125a,b in the feeder assembly 100) each of the plurality of additional meshes have different sized openings. It should be understood that in the present application the “openings” of a mesh are the spaces which are defined by the network of wires/members which define the mesh. A user selects which mesh to use in the feeding assembly depending on the size of the good components which are to be fed in the feeding assembly. Most preferably the size of the openings in mesh which defines the first mesh 105a are larger than dimensions of a good component so that a good component can pass through said openings in the first mesh 105a and fall onto the first base 106b; the size of the openings in mesh which defines the second mesh 105b are smaller than the dimensions of said good component so that good components are unable to fall through said openings in the second mesh 105b, thereby ensuring that the good components can be moved to the second intermediate track 150b in the feeding assembly 100.

The remaining parts of the assembly are similar to those shown in the embodiment of FIGS. 1a and 1b.

During operation a user preferably first determines the dimensions of a sample good component which is to be fed using the feeding assembly 100. Based on the determined dimensions the user selects the appropriate meshes (from a plurality of meshes each mesh have different sized openings) to use as the first and second meshes 105a,105b in the assembly. Most preferably for the first mesh 105a the user selects a mesh having openings which are larger than the dimensions of the sample good component so that good components which are fed can pass through said openings in the first mesh 125a and onto the first base 106b; for the second mesh 105b the user selects a mesh having openings which are smaller than the dimensions of the sample good component so that good components which are fed are unable to fall through said openings in the second mesh 125b. Once the user has selected the appropriate meshes to use, the user inserts the selected meshes into the assembly so that they are arranged to define the first and second meshes 105a, 105b of the assembly 100.

The components (good components and malformed components) and particles are loaded into the bowl hopper 103.

The bowl hopper 103 is then operated so that components (good components and malformed components) and particles are passed from the bowl hopper 103, onto the first sorting track 105a; specifically components (good components and malformed components) and particles are passed from the bowl hopper 103, onto the surface of the first mesh 125a, via the mouth 103a of the bowl hopper 103. The first vibration means 111a vibrates the first sorting track 105a to cause the components to move along the first sorting track 105a.

Malformed components and particles which are too large to pass through the openings in the first mesh 125a, will remain on the surface of the first mesh 125, and will be moved along the surface of the first mesh 125 (by the vibrations of the first sorting track 105a caused by the first vibrations means 111a) and into the first bin 107a. Components (including the good components and malformed components (which may include broken components)) and particles which are small enough to pass through the openings in the first mesh 105a, will fall, under the influence of gravity, through the openings in the first mesh 105a, onto the first base 106a; these components and particles are then moved along the first base 106a (by the vibrations of the first sorting track 105a caused by the first vibrations means 111a) and onto the first intermediary track 150a.

The components (including the good components and malformed components (which may include broken components)) and particles which are moved onto the first intermediary track 150a, will slide (under the influence of gravity) along the first intermediary track 150a and, onto the second sorting track 105b.

The second vibration means 111b vibrates the second sorting track 105b to cause the components (including the good components and malformed components (which may include broken components)) and particles to move along the second sorting track 105b.

Components (malformed components (which may include broken components) and particles which are small enough to pass through the second mesh 105b, will fall, under the influence of gravity, through the openings in the second mesh 105b, onto the second base 106b; these components and particles are then moved along the second base 106b (by the vibrations of the second sorting track 105b caused by the second vibration means 111b) and into the second bin 107b. The good components have dimensions which are too large to allow them to pass through the openings in the second mesh 105b. Thus only good components will remain on the surface of the second mesh 105b, the larger malformed components and larger particles having been dumped in first bin 107a and the smaller particles and smaller malformed components having been dumped in the second bin 107b. The good components will be moved along the surface of the second mesh 105b (by the vibrations of the second sorting track 105b caused by the second vibrations means 111b) and onto second intermediary track 150b.

The good components which are moved onto the second intermediary track 150b, will slide (under the influence of gravity) along the second intermediary track 150b, and onto the first track 9a.

The first vibrating mean 11 vibrates the first track 9a so that the good components, which have been passed onto the first track 9a from the second intermediary track 150b, are moved, most preferably in single file, along the first track 9a. In other words the vibration of the first track 9a causes the good components which are on the track 9a to shuffle or hop along the first track 9a so that the good components move linearly from one end of the first track 9a to the opposite end of the first track 9a.

Each respective component which is moving along the first track 9a will encounter the baffles 13 which are provided along the first track 9a. Each baffle 13 will mechanically cooperate with the respective good components which move along the first track 9a so as to move said good components into a predefined orientation. If each baffle 13 along the first track 9a is successfully moves a passing good component in the manner in which it is intended, then that good component will have been moved into said predefined orientation.

After the a good component has passed through each of the baffles 13 that good component will arrive a region of the first track 9a which is located beneath the camera 15 (i.e. a region of the first track 9a that the camera 15 overlays). At this position the camera 15 captures an image of the good component.

The image captured by the camera 15 is communicated to the processor 17 which processes the image captured by the camera to determine from the image if the good component (whose image was captured) is in the predefined orientation. Processing the image captured by the camera to determine from the image if the good component (whose image was captured) is in the predefined orientation can be done in any suitable manner; for example the processor 17 may compare the captured image to a reference image which shows a good component in the predefined orientation, and if the position of the good component in the captured image differs from the position of the component in the reference image by an amount which is less than a predefined displacement amount, then it will be determined that the good component is in the predefined orientation, otherwise it determined that the good component is not in the predefined orientation. In another example the fiducials or reference marks are provided on the first track 9a in said region of the first track 9a where the image of the good component is captured, these fiducials or reference marks being in the field of view of the camera 15; the processor 17 then determines from the image the displacement of the good component with respect to these fiducials or reference marks and if the displacement amount is less than a predefined displacement amount, then it will be determined that the good component is in the predefined orientation, otherwise it determined that the good component is not in the predefined orientation. It will be understood that any suitable means known in the art for processing an image of a component to determine if that component is in a predefined position/orientation may be used in the present invention.

If the processor 17 determines that the good component is not in the predefined orientation, then: the processor 17 will first initiate the blower 21 to provide a pulse of airflow which moves the good component from the first track 9a to the second track 9b; more specifically the blower 21 will provide a pulse of airflow which moves the good component from the first track 9a onto the first end 19a of the second track 9b. The second track 9b is vibrated using the second vibrating means 11b; the vibration of the second track 9b moves the good component along the second track 9a, from the first end 19a of the second track 9b to the second end 19b of the second track 9b.

The assembly 100 further comprises a transfer track 9′; the transfer track 9′ is connected between the second end 19b of the second track 9b and the first track 9a. In this example the second end 19b of the second track 9b is positioned higher than the first track 9a, accordingly the transfer track 9′ is tilted; this allows components which arrive at the second end 19b of the second track 9b to slide, under the influence of gravity, along the transfer track 9′, onto the first track 9a.

Accordingly, at the second end 19b of the second track 9b, the good component moves onto the transfer track 9′ and will slide, under the influence of gravity, along the transfer track 9′ onto the first track 9a. Accordingly the good component(s) which arrive at the second end 19b of the second track 9b will be passed directly, from the second end 19b of the second track 9b onto the first track 9a, via the transfer track 9′ (unlike in the assembly 1 of FIGS. 1-3, wherein the components which arrive at the second end 19b of the second track 9b, are passed onto the second mesh of the sorting means, before being passed onto the first track 9a).

The good component 5b will be moved along the first track 9a for a second time where the baffles 13 will attempt, for a second time, to move the good component into said predefined orientation. Again after the good component has been passed along the first track 9a the camera 15 will again take an image of the good component and the processor 17 will process the image to determine if this time the good component is in the predefined orientation. If the processor 17 determines that once again the component is not in the predefined orientation then the above-mentioned steps are repeated.

So in other words when a good component which has been passed along the first track 9a is determined to not be in the predefined orientation then it is sent along the second track 9b, where it is delivered onto the first track 9a via the transfer track 9′; that good component is moved along the first track 9a where once again the baffles will attempt to move that good component into the predefined orientation. These steps are repeated until the good component finally attains the predefined orientation after having passed along the first track 9a.

If the processor 17 determines from the image captured by the camera 15, that a good component (which has passed along the first track 9a) is in the predefined orientation, then that good component then picked from the first track 9a.

Specially, in a further aspect of the present invention there is provided a component handling assembly comprising the above-mentioned feeder assembly 100 and a rotatable turret which comprises a plurality of component handling heads each of which can hold a respective component by means of a vacuum. Said first track 9a has a first end and second, opposite

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1. A feeder assembly comprising;
a hopper which can receive components to be fed, said hopper having a mouth through which said components can be expelled from the hopper;
a sorting means which comprises at least a first mesh and a second mesh having different sized openings, wherein the size of the openings in one of the first or second meshes is larger than the size of the openings in the other mesh, so that the mesh with the larger sized openings can separate good components from malformed components and particles which are larger than the size of a good component, and the mesh with the smaller sized openings can separate good components from malformed components and particles which are smaller than the size of a good component;
a first track which can receive good components from the sorting means;
a first vibration means, for vibrating the first track so as to move said good components along the first track;
one or more baffles positioned along the first track, which can cooperate with said good components which move along the first track to move said good components into a predefined orientation.

2. A feeder assembly according to claim 1 wherein sorting means comprises,
a first sorting track and a second sorting track, wherein the first sorting track comprises a first mesh which is arranged to overlay a first base, and
wherein the second sorting track comprises a second mesh which is arranged to overlay a second base.

3. A feeder assembly according to claim 2 wherein the sorting means further comprises,
a first vibration means which is operably connected to the first sorting track, and is operable to vibrate the first sorting track to cause components on the first sorting track to move along the first sorting track; and
a second vibration means which is operably connected to the second sorting track, and is operable to vibrate the second sorting track to cause components on the second sorting track to move along the second sorting track.

4. A feeder assembly according to claim 2 wherein the sorting means further comprises,
a first intermediate track which is arranged to receive components from the first base and direct said components to the second sorting track; and
a second intermediate track which is arranged to receive components from a surface of the second mesh and direct said components to said first track.

5. A feeder assembly according to claim 2 wherein the sorting means further comprises a first bin which is arranged to receive malformed components and particles which have moved along a surface of the first mesh; and a second bin which is arrange to receive malformed components and particles which have moved along the second base.

6. A feeder assembly according to claim 1 wherein sorting means comprises, a stack of meshes, said stack comprising a first mesh and a second mesh, the first mesh having openings which are larger than openings of the second mesh so that the size of components which can pass through the first mesh are larger than the size of the components which can pass through the second mesh, wherein the first mesh overlays the second mesh so that components which pass through the opening in the first mesh fall onto the second mesh, and wherein said stack is arranged such that components which are expelled through the mouth of the hopper fall onto the first mesh.

7. A feeder assembly according to claim 6 further comprising a vibration means for vibrating the stack.

8. A feeder assembly according to according to claim 6 wherein the second mesh is further provided with a channel which tapers in a direction towards the first track, so that when the second mesh is vibrated components will move along the surface of the second mesh towards the first track.

9. A feeder assembly according to claim 1, further comprising,
a camera which is arranged downstream of said one or more baffles which can capture an image of a component which is on the first track, and
a processing means for processing the image captured by the camera to determine from the image if said component is in a predefined orientation.

10. A feeder assembly according to claim 9 further comprising,
a second track having a first end which is arranged to receive components which have been determined by the processing means to not be in said predefined orientation, from the first track, and a second, opposite end which is arranged to deliver components to the sorting means; and
a second vibration means, for vibrating the second track so as to move components along the second track from the first end to the second, opposite end.

11. A feeder assembly according to claim 9 further comprising,
a second track having a first end which is arranged to receive components which have been determined by the processing means to not be in said predefined orientation, from the first track, and a second, opposite end, which is connected to an intermediate track, wherein the intermediate track is connected between the second end of the second track and the first track so that components arriving at the second end of the second track can pass to the first track via the intermediate track; and
a second vibration means, for vibrating the second track so as to move components along the second track from the first end to the second, opposite end.

12. A method of feeding components using a feeder assembly according to claim 1, the method comprising,
providing a plurality of components in the hopper;
expelling the components from the mouth of the hopper to the sorting means;
separating good components from malformed components and particles using said at least first and second meshes of the sorting means;
passing said good components from the sorting means to the first track;
vibrating the first track using the first vibration means so as to move good components along the first track;
using the one or more baffles positioned along the first track to move said good components so as to attempt to move each good component into a predefined orientation.

13. A method according to claim 12, wherein the step of separating good components from malformed components and particles using said at least first and second meshes of the sorting means, comprises,
vibrating a first separating track to cause malformed components and particles which are too large to pass through openings in the first mesh, to move along the surface of the first mesh and into the first bin; and to cause good components and malformed components and particles which are small enough to pass through openings in the first mesh, fall onto the first base and to move along the first base;
passing the good components and malformed components and particles which were small enough to pass through openings in the first mesh to a second separating track;
vibrating the second separating track to cause malformed components and particles which are small enough to pass through openings in the second mesh, to fall onto a second base and to move along the second base and into a second bin, and to cause good components, which are too large to pass through the openings in the second mesh, move along the surface of the second mesh;
passing the good components which are too large to pass through the openings in the second mesh to said first track.

14. A method according to claim 12, wherein the step of separating good components from malformed components and particles using said at least first and second meshes of the sorting means, comprises,
vibrating the first mesh so that components which are smaller than the openings in the first mesh pass through the openings in first mesh and fall onto the second mesh, and so that components which are larger than the openings in the first mesh as moved to a first bin;
vibrating the second mesh so that components which are smaller than the openings in the second mesh pass through the openings in the second mesh and fall into a second bin, and so that components which are small enough to have passed through the openings in the first mesh but are too large to pass through the openings in the second mesh are moved to the first track.

15. A component handling assembly comprising,
a feeder assembly according to claim 1;
a rotatable turret, comprising a plurality of component handling heads each of which can hold a respective component by means of a vacuum;
wherein said first track of the feeder assembly has a first end and second opposite end, and wherein the feeder assembly is arranged so that the first end of the first track is arranged to receive components from the sorting means, and the second, opposite end of the first track is located under the turret so that component handling heads on the turret can pick components from the second end of the first track.
